(19) United States
(12) Patent Application Publication
(10) Pub. No.: US 2025/0215843 A1
(43) Pub. Date: Jul. 3, 2025

(54) EVAPORATIVE EMISSIONS LEAK CHECK MODULE WITH PROPORTIONAL SOLENOID VALVE

(71) Applicants: Stoneridge Asia Pacific Electronics (Suzhou) Co. Ltd., Suzhou (CN); Stoneridge Control Devices, Inc., Novi, MI (US)

(72) Inventors: Terry Yu, Suzhou (CN); Sean Gao, Suzhou (CN); Wells Jiang, Suzhou (CN)

(21) Appl. No.: 18/621,406

(22) Filed: Mar. 29, 2024

(30) Foreign Application Priority Data
Dec. 29, 2023 (CN) 2023118436014

(51) Int. Cl. F02M 25/08; F02D 41/22

(52) U.S. Cl. CPC F02M 25/0809; F02D 2041/225

(57) ABSTRACT

A leak detection module (LDM) includes a three-position proportional solenoid valve having a charcoal canister port fluidly connected to a charcoal canister connection, a pump port fluidly connected to a first port of a pump, and an atmospheric port fluidly connected to a second port of a pump. The atmospheric port is fluidly connected to atmosphere. A longitudinally movable rod has a seal with first, second and third positions. The seal obstructs the pump port and fluidly connects the charcoal canister port and the atmospheric port in the first position, obstructs the atmospheric portion and fluidly connects the charcoal canister port and the pump port in the second position, and obstructs the charcoal canister port in the third position which fluidly blocks the pump port from the atmospheric port and fluidly separates the first and second ports with the seal.

### PRIORITY CLAIM

This application claims priority to Chinese Patent Application No. 2023118436014 filed Dec. 29, 2023.

### TECHNICAL FIELD

This disclosure relates to a leak detection module (LDM) for an evaporative emissions system. In one example, the disclosure relates to an LDM with a proportional solenoid valve and a method for testing the internal combustion engine evaporative emissions system for leaks using the LDM.

### BACKGROUND

Evaporative emissions systems have long been required for gasoline powered vehicles. The system must undergo a periodic leak test during or after a vehicle drive cycle to ensure that fuel vapors will not leak into the atmosphere. The gasoline engine, a pump, or fuel tank temperature change is used either to create a vacuum or pressurize the system. Various valves may be closed during this test procedure to maintain system pressure, and the pressure is monitored to determine if there are any leaks.

One type of evaporative emissions system uses a leak detection module (LDM) that typically houses a pump and one or more valves that are operated during a test procedure. Two two-way valves are commonly used in an LDM to regulate flow from the pump and relative to atmosphere.

Another example LDM uses a single three-way valve. A recirculation passageway is connecting to opposing ports in one of the valve's operating positions. The pump operates in at least two of the three valve positions, and the atmosphere is always fluidly communicated through the valve.

### SUMMARY

In one exemplary embodiment, a leak detection module (LDM) comprises a housing having a charcoal canister connection configured to be fluidly connected to a charcoal canister. The housing has an atmospheric connection configured to be fluidly connected to atmosphere, and a pump is arranged in the housing and has first and second ports. An electric motor is arranged in the housing and is configured to drive the pump. A three-position proportional solenoid valve is arranged in the housing and includes a housing having a charcoal canister port fluidly connected to the charcoal canister connection, a pump port fluidly connected to the first port by a first pump passageway, and an atmospheric port fluidly connected to the second port by a second pump passageway. The atmospheric port is fluidly connected to the atmospheric connection by an atmospheric passageway. A rod is disposed in a coil and has a seal. The rod is configured to move longitudinally between first, second and third positions. The seal obstructs the pump port and fluidly connects the charcoal canister port and the atmospheric port in the first position, the seal obstructs the atmospheric port and fluidly connects the charcoal canister port and the pump port in the second position, and the seal obstructs the charcoal canister port in the third position which fluidly blocks the pump port from the atmospheric port and fluidly separates the first and second ports with the seal.

In a further embodiment of any of the above, a first and second core are arranged in the coil. The first core slideably supports an end of the rod, and the second core fixedly supported on the rod and is configured to be longitudinally movable with the rod in response to a magnetic field from the coil.

In a further embodiment of any of the above, a spring is arranged within the first core and is operatively connected to the end. The spring is configured to bias the rod to the first position with the coil de-energized.

In a further embodiment of any of the above, the spring is a second spring, and a first spring operatively connected to another end opposite the end. The second spring has a second spring force greater than a first spring force of the first spring.

In a further embodiment of any of the above, the third position is arranged longitudinally between the first and second positions.

In a further embodiment of any of the above, the coil is configured to operate with a duty cycle in a range of 80%-100% in the second position, and the coil is configured to operate with the duty cycle in a range of 40%-60% in the third position.

In a further embodiment of any of the above, fluid is not permitted to pass through the proportional solenoid valve in the third position.

In a further embodiment of any of the above, there is no recirculation path between the first and second ports with the seal in the third position.

In a further embodiment of any of the above, an evaporative emissions system includes the LDM, and the system has a filter arranged between the second pump passageway and the atmosphere. A charcoal canister fluidly is connected to the charcoal canister connection, fluidly connected to an internal combustion engine, and fluidly connected to a fuel tank.

In a further embodiment of any of the above, a controller is in communication with the proportional solenoid valve and the electric motor. The controller is configured to operate the LDM between three operational states, comprising: a non-operational state in which the seal is in the first position, a pressure mode during a testing state in which the seal is in the second position and the pump is configured to move fluid between the canister and atmospheric ports, and a pressure-hold mode during the testing state in which the seal is in the third position.

In a further embodiment of any of the above, the pump is non-operational in the non-operational state and the pressure-hold mode.

In another exemplary embodiment, a method of leak testing an evaporative emissions system includes providing a three-position proportional solenoid valve having a charcoal canister port fluidly connected to a charcoal canister, a pump port fluidly connected to a first port of a pump by a first pump passageway, an atmospheric port fluidly connected to the second port by a second pump passageway, and the atmospheric port fluidly connected to atmosphere by an atmospheric passageway. A rod is disposed in a coil and has a seal, and the rod configured to move longitudinally between first, second and third positions. The seal obstructs the pump port and fluidly connects the charcoal canister port and the atmospheric port in the first position, the seal obstructs the atmospheric port and fluidly connects the charcoal canister port and the pump port in the second position, and the seal obstructs the charcoal canister port in the third position which fluidly blocks the pump port from the atmospheric port and fluidly separates the first and second ports with the seal. The method also includes de-energizing the coil to a non-operational state in which the seal is in the first position, energizing the coil to a pressure mode during a testing state in which the seal is in the second position and energizing the pump to move fluid between the canister and atmospheric, and energizing the coil to a pressure-hold mode during the testing state in which the seal is in the third position.

In a further embodiment of any of the above, the third position is arranged longitudinally between the first and second positions, the coil is energized with a duty cycle in a range of 80%-100% in the second position, and the coil is energized with the duty cycle in a range of 40%-60% in the third position.

In a further embodiment of any of the above, a spring biases the rod to the first position with the coil de-energized.

In a further embodiment of any of the above, fluid is not permitted to pass through the proportional solenoid valve in the third position, and there is no recirculation path between the first and second ports with the seal in the third position.

### BRIEF DESCRIPTION OF THE DRAWINGS

The disclosure can be further understood by reference to the following detailed description when considered in connection with the accompanying drawings wherein:

FIG. 1 schematically illustrates portions of one example evaporative fuel system.

FIG. 2 is a schematic of a leak detection module (LDM) having a proportional solenoid valve and a pump.

FIG. 3 is a cross-sectional view of the proportional solenoid valve in a non-operational state, including a graph of the solenoid's duty cycle for this state.

FIG. 4 is a cross-sectional view of the proportional solenoid valve in a vacuum mode during a testing state, including a graph of the solenoid's duty cycle for this state.

FIG. 5 is a cross-sectional view of the proportional solenoid valve in a pressure-hold mode during the testing state, including a graph of the solenoid's duty cycle for this state.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible. Like reference numbers and designations in the various drawings indicate like elements.

### DETAILED DESCRIPTION

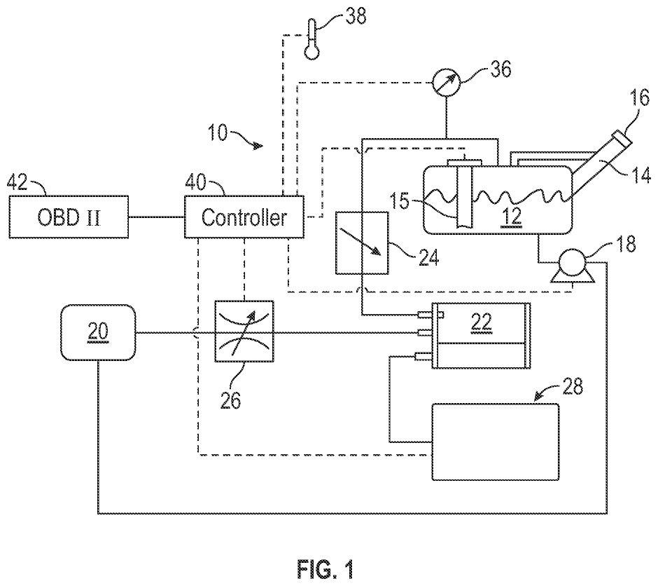

FIG. 1 schematically illustrates a portion of an example evaporative fuel system 10. It should be understood that other types of systems may be used. The system 10 includes a fuel tank 12 having a fuel filler 14 with a fill cap 16. A fuel pump 18 supplies gasoline, for example, from the fuel tank 12 to an internal combustion engine 20, which provides propulsion to a vehicle. A fuel level sensor 15 is in communication with a controller 40, which may be an engine controller, and measures a level of fuel within the fuel tank 12.

The system 10 is configured to capture and regulate the flow of fuel vapors within the system. In one example type of system (e.g. those used in hybrid vehicles), a fuel tank isolation valve (FTIV) 24 is arranged fluidly between the fuel tank 12 and a charcoal canister 22, which captures and stores fuel vapors for later use by the engine 20. A purge valve 26 is fluidly connected between the canister 22 and the engine 20. In one example, the controller 40 regulates a position of the purge valve 26 during engine operation in response to a purge command from the engine controller 40, for example, to selectively provide the fuel vapors to the engine 20 during fuel combustion to make use of these fuel vapors. The LDM 28 may also have its own controller separate and discrete from the engine controller 40.

Regarding the evaporative emissions system, the integrity of the system 10 must be periodically tested to ensure no fuel vapor leakage. One type of system 10 uses a leak detection module (LDM) 28 (also referred to as a “leak check module”), which can be used to pull a vacuum and/or pressurize the system to determine whether a leak exists, for example, using a pressure transducer (e.g., within the LDM 28). In one example leak test procedure, the purge valve 26 is closed and the leak detection module 28 is used to evacuate or pressurize the system. Another pressure transducer 36 may be used to monitor the pressure of fuel vapors within the fuel tank 12 during other conditions. In one example, a temperature sensor 38 is arranged outside the LDM 28. The temperature sensor 38 may be useful for quantify heat transfer characteristics of the fuel vapor within the fuel tank 12 relative to surrounding atmospheric temperature.

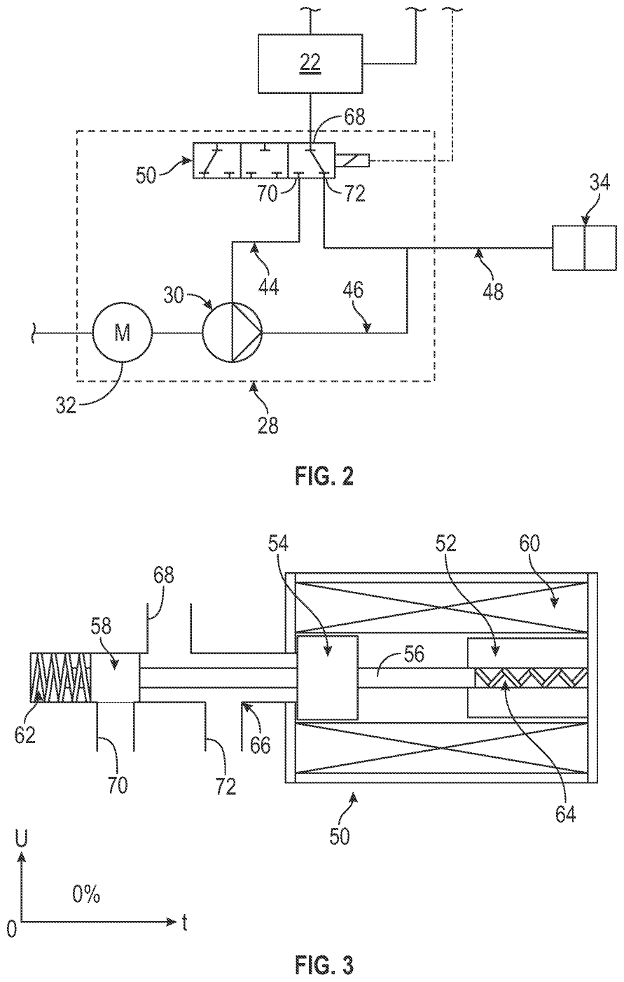

The LDM 28 is schematically shown in FIG. 2. The LDM 28 includes a pump 30 rotationally driven by an electric motor 32 and arranged in a common housing, which is typically provided by a multi-piece plastic structure. The housing typically has two fluid connections or openings: a charcoal canister connection fluidly connected to the charcoal canister 22, and an atmospheric connection in fluid communication with the atmosphere. A filter 34 may be arranged between the atmosphere and the pump 30 to prevent debris from entering the LDM 28. A three-way proportional solenoid valve 50 (generally, “solenoid valve 50”) is arranged in the LDM 28 and regulates the flow between the pump 30 and/or atmosphere to and/or from the charcoal canister 22 during various operating conditions, including leaking testing of the system.

The pump 30 (e.g., a vane pump) has first and second ports. Referring to FIGS. 2 and 3, the solenoid valve 50 has a housing 66 having a charcoal canister port 68 fluidly connected to the charcoal canister connection (connected to the charcoal canister 22). A pump port 70 is provided in the housing 66 and is fluidly connected to the first port of the pump 30 by a first pump passageway 44. An atmospheric port 72 in the housing 66 is fluidly connected to the second port of the pump 30 by a second pump passageway 46. The atmospheric port 72 is also fluidly connected to the atmospheric connection (in communication with the atmosphere) by an atmospheric passageway 48.

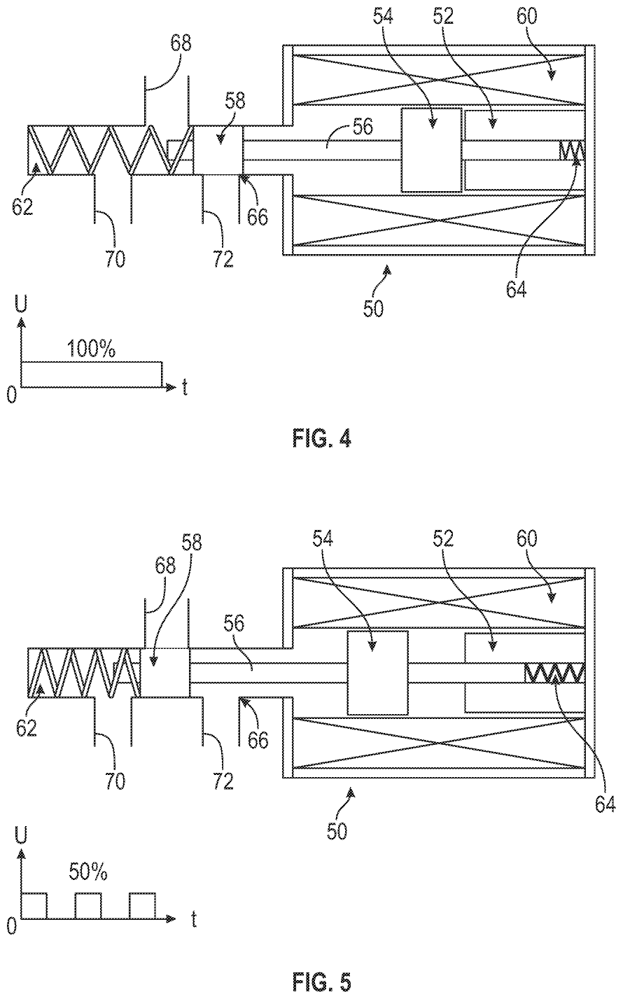

The solenoid valve 50 includes a rod 56 at least partially disposed in a copper wire coil 60. In the example, a fixed first core 52 is arranged inside and at one end of the coil 60. The first core 52 slideably supports an end of the rod 56. A second core 54 (ferrous) is fixedly supported on the rod 56 and is longitudinally movable with the rod 56 in response to a magnetic field from the coil 60. A seal 58 is provided on the rod 56 and moves longitudinally between a first position (FIG. 3), a second position (FIG. 4) and a third position (FIG. 5) to selectively block the canister, pump and atmospheric ports 68, 70, 72. The third position is arranged longitudinally between the first and second positions.

The method of operating the LDM 28 using the controller 40 includes de-energizing the coil 60 to a non-operational state in which the seal 58 is in the first position. This is the state that is used during typical engine operation. The method includes energizing the coil 60 to a pressure mode (i.e., positive or negative pressure) during a testing state in which the seal 58 is in the second position, and then energizing the pump 30 to move fluid between the carbon canister 22 and atmosphere. The method also includes energizing the coil 60 to a pressure-hold mode during the testing state in which the seal 58 is in the third position.

With continuing reference to FIG. 3, a first spring 62 is arranged between the seal 58 and the housing 66 at one end of the rod 56, and a second spring 64 is operatively connected to another end opposite the end. The second spring 64 has a second spring force greater than a first spring force of the first spring 62. The second spring 64 is configured to bias the rod 56 (and its seal 58) to the first position with the coil de-energized (pulse width modulation (PWM) 0% duty cycle), as shown in FIG. 3. The seal 58 obstructs the pump port 70 and fluidly connects the charcoal canister port 68 and the atmospheric port 72 in the first position (FIG. 3). This operating condition is suitable for desorbing the carbon canister 22 (in which air from the atmosphere is pulled through the filter 34) or refueling the fuel tank 12 (in which air is pushed out to the atmosphere).

The seal 58 obstructs the atmospheric port 72 and fluidly connects the charcoal canister port 68 and the pump port 70 in the second position (FIG. 4). The second position is used when it is necessary to diagnose leaks in the evaporation system. Some customers prefer a system that operates using a vacuum, while other customers prefer a system that is pressurized. The rotational direction of the pump determines whether the system is pressurized or a vacuum is applied. So, to provide a pressurized evaporative emissions system test, the pump 30 will draw air from the atmosphere through the filter 34 and direct the air towards the charcoal canister 22. To provide a depressurized or negative pressure evaporative emissions system test (i.e., vacuum), the pump 30 will draw air from the charcoal canister 22 and out to the atmosphere.

Positive pressurization or negative pressurization (vacuum) of the evaporation system is performed to establish a target pressure value. The positive pressure and negative pressure modes can be switched according to the diagnostic requirements. With the seal 58 in the second position, the controller 40 the purge valve 26 to close and provides a voltage to the coil 60 at a duty cycle in a range of 80%-100% (e.g., 100% duty cycle), for example. The coil 60 in turn generates a magnetic field that moves the second core 54 into abutment with the first core 52, which overcomes the spring force of the second spring 64. At this time, air from the atmosphere is blocked, and the pump 30 is connected to the carbon canister 22. The controller 40 energizes the pump 30, and the pressure sensor 36 monitors the pressure value in real time. If the system pressure value reaches the preset threshold P1 within T0 time, the next diagnostic stage can be entered. If the system pressure value does not reach the preset threshold P1 within TO time, the OBDII system 42 will report a large leakage fault of the evaporation system and the diagnosis will be completed.

The seal 58 obstructs the charcoal canister port 68 in the third position (FIG. 5), which fluidly blocks the pump port 70 from the atmospheric port 72 and fluidly separates the first and second ports of the pump 30 with the seal 58. In the third position, fluid is not permitted to pass through the solenoid valve 50, and there is no recirculation path between the first and second ports of the pump 30. When the pressure value of the fuel evaporation system reaches the preset threshold P1, the leakage diagnosis enters the second stage, i.e., the seal 58 in the third position. The purge valve 26 remains closed, and the coil 60 is provided the voltage at a range of 40%-60% (e.g., 50% duty cycle, that is, the average voltage obtained by the coil is only 50% of the rated voltage). The electromagnetic force generated by the coil 60 is attenuated and is not enough to completely overcome the first and second springs 62, 64, which results in the seal 58 arranged in the middle position. The pump 30 need not operate during this phase of the test.

At this time, the canister, pump and atmospheric ports 68, 70, 72 of the housing 66 are not fluidly connected to each other. The solenoid valve 50 in this way acts similar to a fuel tank isolation valve 24, completely sealing the evaporation system but on an opposite side of the carbon canister 22. The pressure sensor 36 to monitor the pressure attenuation in the system. The controller 40 interpolates and compares the pressure attenuation curve of the preset standard 0.5 mm or 1.0 mm hole during bench calibration to determine whether the actual leakage has reached the leakage alarm threshold. At this point, after the diagnosis is completed, the controller 40 cuts off power to the solenoid valve 50, the electromagnetic force dissipates, and the seal 58 to the first position shown in FIG. 3.

The controller 40 and OBDII system 42 may be integrated or separate. In terms of hardware architecture, such the controllers can include a processor, memory, and one or more input and/or output (I/O) device interface(s) that are communicatively coupled via a local interface. The local interface can include, for example but not limited to, one or more buses and/or other wired (e.g., CAN, LIN and/or LAN) or wireless connections. The local interface may have additional elements, which are omitted for simplicity, such as controllers, buffers (caches), drivers, repeaters, and receivers to enable communications. Further, the local interface may include address, control, and/or data connections to enable appropriate communications among the aforementioned components.

The controllers may be a hardware device for executing software, particularly software stored in memory. The processor can be a custom made or commercially available processor, a central processing unit (CPU), an auxiliary processor among several processors associated with the controllers, a semiconductor based microprocessor (in the form of a microchip or chip set) or generally any device for executing software instructions.

The memory can include any one or combination of volatile memory elements (e.g., random access memory (RAM, such as DRAM, SRAM, SDRAM, VRAM, etc.)) and/or nonvolatile memory elements (e.g., ROM, etc.). Moreover, the memory may incorporate electronic, magnetic, optical, and/or other types of storage media. The memory can also have a distributed architecture, where various components are situated remotely from one another, but can be accessed by the controller.

The software in the memory may include one or more separate programs, each of which includes an ordered listing of executable instructions for implementing logical functions. A system component embodied as software may also be construed as a source program, executable program (object code), script, or any other entity comprising a set of instructions to be performed. When constructed as a source program, the program is translated via a compiler, assembler, interpreter, or the like, which may or may not be included within the memory.

When the controllers are in operation, its processor can be configured to execute software stored within the memory, to communicate data to and from the memory, and to generally control operations of the computing device pursuant to the software. Software in memory, in whole or in part, is read by the processor, perhaps buffered within the processor, and then executed.

It should also be understood that although a particular component arrangement is disclosed in the illustrated embodiment, other arrangements will benefit herefrom. Although particular step sequences are shown, described, and claimed, it should be understood that steps may be performed in any order, separated or combined unless otherwise indicated and will still benefit from the present invention.

Although the different examples have specific components shown in the illustrations, embodiments of this invention are not limited to those particular combinations. It is possible to use some of the components or features from one of the examples in combination with features or components from another one of the examples. For example, the disclosed pump may be used in applications other than vehicle evaporative systems.

Although an example embodiment has been disclosed, a worker of ordinary skill in this art would recognize that certain modifications would come within the scope of the claims. For that reason, the following claims should be studied to determine their true scope and content.

What is claimed is:

1. A leak detection module (LDM) comprising:
a housing having a charcoal canister connection configured to be fluidly connected to a charcoal canister, the housing having an atmospheric connection configured to be fluidly connected to atmosphere;
a pump arranged in the housing and having first and second ports;
an electric motor arranged in the housing and configured to drive the pump; and
a three-position proportional solenoid valve arranged in the housing and including:
a housing having a charcoal canister port fluidly connected to the charcoal canister connection, a pump port fluidly connected to the first port by a first pump passageway, and an atmospheric port fluidly connected to the second port by a second pump passageway, and the atmospheric port fluidly connected to the atmospheric connection by an atmospheric passageway, and
a rod disposed in a coil and having a seal, the rod configured to move longitudinally between first, second and third positions, the seal obstructing the pump port and fluidly connecting the charcoal canister port and the atmospheric port in the first position, the seal obstructing the atmospheric port and fluidly connecting the charcoal canister port and the pump port in the second position, and the seal obstructing the charcoal canister port in the third position which fluidly blocks the pump port from the atmospheric port and fluidly separates the first and second ports with the seal.

2. The LDM of claim 1, comprising a first and second core arranged in the coil, the first core slideably supporting an end of the rod, the second core fixedly supported on the rod and configured to be longitudinally movable with the rod in response to a magnetic field from the coil.

3. The LDM of claim 2, comprising a spring within the first core and operatively connecting to the end, the spring configured to bias the rod to the first position with the coil de-energized.

4. The LDM of claim 3, wherein the spring is a second spring, and comprising a first spring operatively connected to another end opposite the end, the second spring having a second spring force greater than a first spring force of the first spring.

5. The LDM of claim 1, wherein the third position is arranged longitudinally between the first and second positions.

6. The LDM of claim 5, wherein the coil is configured to operate with a duty cycle in a range of 80%-100% in the second position, and the coil is configured to operate with the duty cycle in a range of 40%-60% in the third position.

7. The LDM of claim 1, wherein fluid is not permitted to pass through the proportional solenoid valve in the third position.

8. The LDM of claim 7, wherein there is no recirculation path between the first and second ports with the seal in the third position.

9. An evaporative emissions system including the LDM of claim 1, the system comprising a filter arranged between the second pump passageway and the atmosphere, and a charcoal canister fluidly connected to the charcoal canister connection, fluidly connected to an internal combustion engine, and fluidly connected to a fuel tank.

10. The system of claim 9, comprising a controller, the controller in communication with the proportional solenoid valve and the electric motor, the controller configured to operate the LDM between three operational states, comprising:
a non-operational state in which the seal is in the first position;
a pressure mode during a testing state in which the seal is in the second position, and the pump is configured to move fluid between the canister and atmospheric ports; and
a pressure-hold mode during the testing state in which the seal is in the third position.

11. The system of claim 9, wherein the pump is non-operational in the non-operational state and the pressure-hold mode.

12. A method of leak testing an evaporative emissions system, comprising:
providing a three-position proportional solenoid valve including:
a charcoal canister port fluidly connected to a charcoal canister,
a pump port fluidly connected to a first port of a pump by a first pump passageway,
an atmospheric port fluidly connected to the second port by a second pump passageway, and the atmospheric port fluidly connected to atmosphere by an atmospheric passageway, and
a rod disposed in a coil and having a seal, the rod configured to move longitudinally between first, second and third positions, the seal obstructing the pump port and fluidly connecting the charcoal canister port and the atmospheric port in the first position, the seal obstructing the atmospheric port and fluidly connecting the charcoal canister port and the pump port in the second position, and the seal obstructing the charcoal canister port in the third position which fluidly blocks the pump port from the atmospheric port and fluidly separates the first and second ports with the seal, and
de-energizing the coil to a non-operational state in which the seal is in the first position;
energizing the coil to a pressure mode during a testing state in which the seal is in the second position, and energizing the pump to move fluid between the canister and atmospheric; and
energizing the coil to a pressure-hold mode during the testing state in which the seal is in the third position.

13. The method of 12, wherein the third position is arranged longitudinally between the first and second positions, the coil is energized with a duty cycle in a range of 80%-100% in the second position, and the coil is energized with the duty cycle in a range of 40%-60% in the third position.

14. The method of 13, wherein a spring biases the rod to the first position with the coil de-energized.

15. The method of 13, wherein fluid is not permitted to pass through the proportional solenoid valve in the third position, and there is no recirculation path between the first and second ports with the seal in the third position.
